(19) United States
(12) Patent Application Publication
(10) Pub. No.: US 2019/0004639 A1
(43) Pub. Date: Jan. 3, 2019

(54) PROVIDING LIVING AVATARS WITHIN VIRTUAL MEETINGS

(71) Applicant: Microsoft Technology Licensing, LLC, Redmond, WA (US)

(72) Inventor: Jason Thomas FAULKNER, Seattle, WA (US)

(21) Appl. No.: 15/637,797

(22) Filed: Jun. 29, 2017

(51) Int. Cl. G06F 3/048; G06Q 10/06; G06Q 10/10; H04L 29/06

(52) U.S. Cl. CPC G06F 3/048; G06Q 10/0631; G06Q 10/109; G06F 3/00; A63F 2300/5553; A63F 2300/8082; H04L 67/38

(57) ABSTRACT

Systems and methods for providing a living avatar within a virtual meeting. One system includes an electronic processor. The electronic processor is configured to receive a position of a cursor-control device associated with a first user within the virtual meeting. The electronic processor is configured to receive live image data collected by an image capture device associated with the first user. The electronic processor is configured to provide, to the first user and a second user, an object within the virtual meeting. The object displays live visual data based on the live image data and the object moves with respect to the position of the cursor-control device associated with the first user.

### FIELD

Embodiments described herein relate to multi-user virtual meetings, and, more particularly, to providing living avatars within such virtual meetings.

### SUMMARY

Virtual meeting or collaboration environments allow groups of users to engage with one another and with shared content. Shared content, such as a desktop or an application window, is presented to all users participating in the virtual meeting. All users can view the content, and users may be selectively allowed to control or edit the content. Users communicate in the virtual meeting using voice, video, text, or a combination thereof. Also, in some environments, multiple cursors, each from a different user, are presented within the shared content. Accordingly, the presence of multiple users, cursors, and modes of communication may make it difficult for users to identify who is speaking or otherwise conveying information to the group. For example, even when a live video is displayed within the virtual meeting from one or more users, users may find it difficult to track what user is currently speaking, what cursor or other input is associated with user, and, similarly, what cursor is associated with a current speaker.

Thus, embodiments described herein provide, among other things, systems and methods for providing living avatars within a virtual meeting. For example, in some embodiments, a user's movements and facial expressions are captured by a camera on the user's computing device, and the movements and expressions are used to animate an avatar within the virtual meeting. The avatar reflects what a user is doing not just who the user is. For example, living avatars may indicate who is currently speaking or may reflect a user's body language, which allows for more natural interactions between users.

To create a living avatar, the avatar is associated with and moves with the user's cursor. Thus, as the user moves his or her cursor, other users can simultaneously view the movement of the cursor and the avatar and not be forced to focus on only one area within the virtual meeting. In some embodiments, live video may be used in place of an avatar and may be similarly associated with the user's cursor. Similarly, when a user provides audio data but not video data (live or as an avatar), the audio data may be represented as an animation (an object that pulses or changes shape or color based on the audio data) associated with the user's cursor. Thus, the living avatars associate live user interactions within a virtual meeting (in video form, avatar form, audio form, or a combination thereof) with a user's cursor or other input mechanism or device to enhance collaboration.

For example, one embodiment provides a system for providing a living avatar within a virtual meeting. The system includes an electronic processor. The electronic processor is configured to receive a position of a cursor-control device associated with a first user within the virtual meeting. The electronic processor is configured to receive live image data collected by an image capture device associated with the first user. The electronic processor is configured to provide, to the first user and a second user, an object within the virtual meeting. The object displays live visual data based on the live image data and the object moves with respect to the position of the cursor-control device associated with the first user.

Another embodiment provides a method for providing a living avatar within a virtual meeting creating a virtual meeting. The method includes receiving, with an electronic processor, a position of a cursor-control device associated with a first user within the virtual meeting. The method includes receiving, with the electronic processor, live image data collected by an image capture device associated with the first user. The method includes providing, with the electronic processor, an object to the first user and a second user within the virtual meeting. The object displays the live image data and the object moves with respect to the position of the cursor-control device associated with the first user.

Another embodiment provides a non-transitory computer-readable medium including instructions executable by an electronic processor to perform a set of functions. The set of functions includes receiving a position of a cursor-control device associated with a first user within a virtual meeting. The set of functions includes receiving live data collected by a data capture device associated with the first user. The set of functions includes providing an object to the first user and a second user within the virtual meeting. The object displays data based on the live data and the object moves with respect to the position of the cursor-control device associated with the first user. The data include at least one selected from a group consisting of live image data captured by the data capture device, a live avatar representation based on live image data captured by the data capture device, and a live animation based on live audio data captured by the data capture device.

### BRIEF DESCRIPTION OF THE DRAWINGS

FIG. 1 schematically illustrates a system for conducting a virtual meeting according to some embodiments.

FIG. 2 schematically illustrates a server included in the system of FIG. 1 according to some embodiments.

FIG. 3 schematically illustrates a computing device included in the system of FIG. 1 according to some embodiments.

FIG. 4 is a flowchart illustrating a method of providing cursors within a virtual meeting performed by the system of FIG. 1 according to some embodiments.

FIGS. 5-8 illustrate example graphical user interfaces generated by the system of FIG. 1 according to some embodiments of the invention.

### DETAILED DESCRIPTION

One or more embodiments are described and illustrated in the following description and accompanying drawings. These embodiments are not limited to the specific details provided herein and may be modified in various ways. Furthermore, other embodiments may exist that are not described herein. Also, the functionality described herein as being performed by one component may be performed by multiple components in a distributed manner. Likewise, functionality performed by multiple components may be consolidated and performed by a single component. Similarly, a component described as performing particular functionality may also perform additional functionality not described herein. For example, a device or structure that is “configured” in a certain way is configured in at least that way, but may also be configured in ways that are not listed. Furthermore, some embodiments described herein may include one or more electronic processors configured to perform the described functionality by executing instructions stored in non-transitory, computer-readable media. Similarly, embodiments described herein may be implemented as non-transitory, computer-readable media storing instructions executable by one or more electronic processor to perform the described functionality. As used in the present application, “non-transitory computer-readable medium” comprises all computer-readable media but does not consist of a transitory, propagating signal. Accordingly, non-transitory computer-readable medium may include, for example, a hard disk, a CD-ROM, an optical storage device, a magnetic storage device, a ROM (Read Only Memory), a RAM (Random Access Memory), register memory, a processor cache, or any combination thereof.

In addition, the phraseology and terminology used herein is for the purpose of description and should not be regarded as limiting. For example, the use of “including,” “containing,” “comprising,” “having,” and variations thereof herein is meant to encompass the items listed thereafter and equivalents thereof as well as additional items. The terms “connected” and “coupled” are used broadly and encompass both direct and indirect connecting and coupling. Further, “connected” and “coupled” are not restricted to physical or mechanical connections or couplings and can include electrical connections or couplings, whether direct or indirect. In addition, electronic communications and notifications may be performed using wired connections, wireless connections, or a combination thereof and may be transmitted directly or through one or more intermediary devices over various types of networks, communication channels, and connections. Moreover, relational terms such as first and second, top and bottom, and the like may be used herein solely to distinguish one entity or action from another entity or action without necessarily requiring or implying any actual such relationship or order between such entities or actions.

As described above, it may be difficult for users in a virtual meeting to track what inputs are provided by other users in the meeting. For example, it may be difficult to track what user is speaking and whether or not the user is also controlling a cursor or similar user input device within the meeting. Accordingly, embodiments described herein creating living avatars (or other types of user inputs) that associate video (live or avatar), audio data, or a combination thereof with the cursor so that other users can quickly and easily identify what cursor is associated with each user in the meeting and each user's current interaction with the shared content.

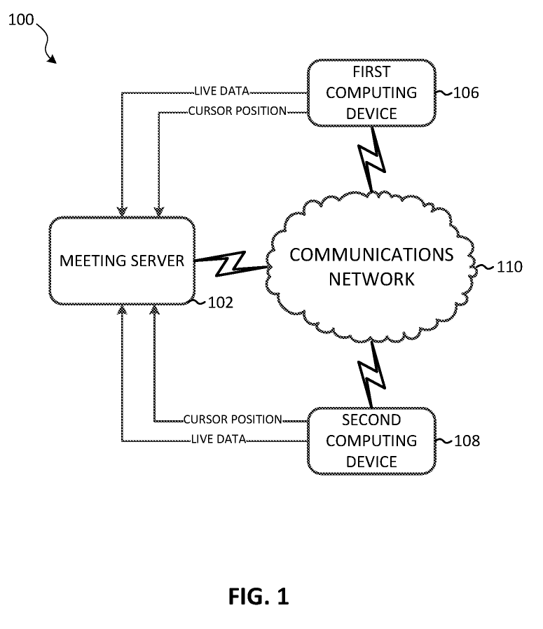

For example, FIG. 1 schematically illustrates a system 100 for conducting a virtual meeting. In the example illustrated in FIG. 1, the system 100 includes a meeting server 102, a first computing device 106, and a second computing device 108. It should be understood that the system 100 is provided as an example and, in some embodiments, the system 100 includes additional components. For example, the system 100 may include multiple servers, one or more databases, computing devices in addition to the first computing device 106 and the second computing device 108, or a combination thereof. In particular, it should be understood that although FIG. 1 illustrates two computing devices 106, 108, the system 100 may include tens, hundreds, or thousands of computing devices to allow tens, hundreds, or thousands of users participate in one or more virtual meetings.

The meeting server 102, the first computing device 106, and the second computing device 108 are communicatively coupled via a communications network 110. The communications network 110 may be implemented using a wide area network, such as the Internet, a local area network, such as a Bluetooth™ network or Wi-Fi, a Long Term Evolution (LTE) network, a Global System for Mobile Communications (or Groupe Special Mobile (GSM)) network, a Code Division Multiple Access (CDMA) network, an Evolution-Data Optimized (EV-DO) network, an Enhanced Data Rates for GSM Evolution (EDGE) network, a 3G network, a 4G network, and combinations or derivatives thereof.

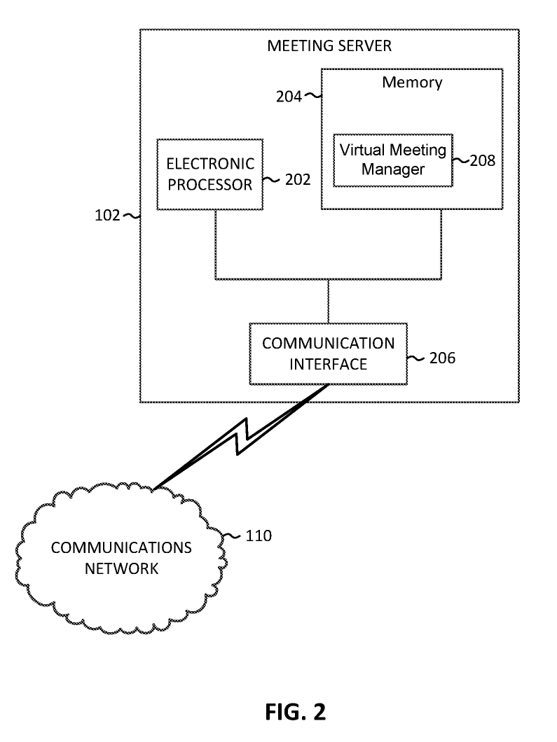

FIG. 2 schematically illustrates the meeting server 102 in more detail. As illustrated in FIG. 2, the meeting server 102 includes an electronic processor 202 (for example, a microprocessor, application-specific integrated circuit (ASIC), or another suitable electronic device), a memory 204 (for example, a non-transitory, computer-readable storage medium), and a communication interface 206, such as a transceiver, for communicating over the communications network 110 and, optionally, one or more additional communication networks or connections. It should be understood that the meeting server 102 may include additional components than those illustrated in FIG. 2 in various configurations and may perform additional functionality than the functionality described in the present application. Also, it should be understood that the functionality described herein as being performed by the meeting server 102 may be distributed among multiple devices, such as multiple servers providing a cloud environment.

The electronic processor 202, the memory 204, and the communication interface 206 included in the meeting server 102 communicate over one or more communication lines or buses, wirelessly, or by a combination thereof. The electronic processor 202 is configured to retrieve from the memory 204 and execute, among other things, software to perform the methods described herein. For example, as illustrated in FIG. 2, the memory 204 stores a virtual meeting manager 208. The virtual meeting manager 208 allows users of the first computing device 106 and the second computing device 108 (and optionally users using similar computing devices (not shown)) to simultaneously conduct virtual meetings and, optionally, view and edit shared content. The shared content may be a desktop of the first or second computing devices 106, 108, a software application (for example, Microsoft Powerpoint®), a document stored within a cloud environment, a broadcast or recording, or the like. Within the virtual meeting, users can communicate via audio, video, text (instant messaging), and the like. For example, in some embodiments, the virtual meeting manager 208 is the Skype® for Business software application provided by Microsoft Corporation. It should be understood that the functionality described herein as being performed by the virtual meeting manager 208 may be distributed among multiple applications executed by the meeting server 102, other computing devices, or a combination thereof.

In some embodiments, the memory 204 also stores user profiles used by the virtual meeting manager 208. The user profiles may specify personal and account information (an actual name, a screen name, an email address, a phone number, a location, a department, a role, an account type, and the like), meeting preferences, type or other properties of the user's associated computing device, avatar selections, and the like. In some embodiments, the memory 204 also stores recordings of virtual meetings or other statistics or logs of virtual meetings. All or a portion of this data may also be stored on external devices, such as one or more databases, user computing devices, or the like.

As illustrated in FIG. 1, the virtual meeting manager 208 (when executed by the electronic processor 202) may send and receive shared content to and from the first computing device 106 and the second computing device 108. It should be understood that, in some embodiments, the shared content is received from other sources, such as the meeting server 102, other devices (databases) accessible by the meeting server 102, or a combination thereof. Also, in some virtual meetings, no content is shared.

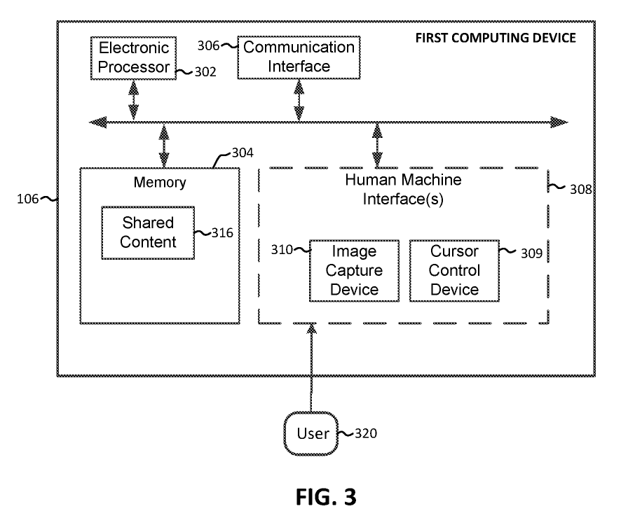

The first computing device 106 is a personal computing device (for example, a desktop computer, a laptop computer, a terminal, a tablet computer, a smart telephone, a wearable device, a virtual reality headset or other equipment, a smart white board, or the like). For example, FIG. 3 schematically illustrates the first computing device 106 in more detail according to one embodiment. As illustrated in FIG. 3, the first computing device 106 includes an electronic processor 302 (for example, a microprocessor, application-specific integrated circuit (ASIC), or another suitable electronic device), a memory 304, a communication interface 306 (for example, a transceiver, for communicating over the communications network 110), a human machine interface (HMI) 308, including, for example, a cursor-control device 309 and a data capture device 310. The illustrated components included in the first communication device 106 communicate over one or more communication lines or buses, wirelessly, or by a combination thereof. It should be understood that the first computing device 106 may include additional components than those illustrated in FIG. 3 in various configurations and may perform additional functionality than the functionality described in the present application. The second computing device 108 may also be a personal computing device that includes similar components as the first computing device 106 although not described herein for sake of brevity. However, it should be understood that the first computing device 106 and the second computing device 108 need not be the same type of computing device. For example, in some embodiments, the first computing device 106 may be virtual reality headset and glove and the second computing device 108 may be a tablet computer or a smart white board.

The memory 304 included in the first computing device 106 includes a non-transitory, computer-readable storage medium. The electronic processor 302 is configured to retrieve from the memory 304 and execute, among other things, software related to the control processes and methods described herein. For example, the electronic processor 302 may execute a software application to access and interact with the virtual meeting manager 208. In particular, the electronic processor 302 may execute a browser application or a dedicated application to communicate with the meeting server 102. As illustrated in FIG. 3, the memory 304 may also store, among other things, shared content 316 (for example, as sent to or received from the meeting server 102).

The human machine interface (HMI) 308 receives input from a user (for example the user 320), provides output to a user, or a combination thereof. For example, the HMI 308 may include a keyboard, keypad, buttons, a microphone, a display device, a touchscreen, or the like for interacting with a user. As illustrated in FIG. 3, in one embodiment, the HMI 308 includes the cursor-control device 309, such as a mouse, a trackball, a joystick, a stylus, a gaming controller, a touchpad, a touchscreen, a dial, a virtual reality headset or glove, a keypad, a keyboard, or the like. The cursor-control device 309 provides input to the first computing device 106 to control the movement of a cursor or other movable indicator or representation within a user interface output by the first computing device 106. The cursor-control device 309 may position a cursor within a two-dimensional space, for example a computer desktop environment, or it may position a cursor within a three-dimensional space, for example, in virtual or augmented reality environments.

In some embodiments, the first computing device 106 communicates with or is integrated with a head-mounted display (HMD), an optical head-mounted display (OHMD), or the display of a pair of smart glasses. In such embodiments, the HMD, OHMD, or the smart glasses may act as or supplement input from the cursor-control device 309.

Also, in some environments, the cursor-control device is the first computing device 106. For example, the first computing device 106 may be a smart telephone operating in an augmented reality mode, wherein movement of the smart telephone acts as a cursor-control device. In particular, as the first computing device 106 is moved, a motion capture device, such as an accelerometer, senses directional movement of the first computing device 106 in one or more dimensions. The motion capture device transmits the measurements the electronic processor 302. In some embodiments, the motion capture device is integrated into another sensor or device (for example, combined with a magnetometer in an electronic compass). Accordingly, in some embodiments, the motion of the first computing device 106 may be used to control the movement of a cursor (for example, within an augmented reality environment). In some embodiments, the movement of the user through a physical or virtual space is tracked (for example, by the motion capture device) to provide cursor control.

As illustrated in FIG. 3, the HMI 308 also includes the data capture device 310. In some embodiments, the data capture device 310 includes sensors and other components (not shown) for capturing images by, for example, sensing light in at least the visible spectrum. In some embodiments, the data capture device 310 is an image capture device, for example, a still or video camera, which may be external to a housing of the first computing device 106 or integrated into the first computing device 106. The camera communicates captured images to the electronic processor 302. It should be noted that the terms “image” and “images” as used herein may refer to one or more digital images captured by the image capture device or processed by the electronic processor 302. Furthermore, the terms “image” and “images” as used herein may refer to still images or sequences of images (for example, a video stream). In some embodiments, the camera is positioned to capture live image data (for example, HD video) of the user 320 as he or she interacts with the first computing device 106. In some embodiments, the data capture device 310 is or includes other types of sensors for capturing movements or the location of a user (for example, infrared sensors, ultrasonic sensors, accelerometers, other types of motion sensors, and the like).

In some embodiments, the data capture device 310 captures audio data (in addition to or as an alternative to image data). For example, the data capture device 310 may include a microphone for capturing audio data, which may be external to a housing of the first computing device 106 or integrated into the first computing device 106. The microphone senses sound waves, converts the sound waves to electrical signals, and communicates the electrical signals to the electronic processor 202. The electronic processor 302 processes the electrical signals received from the microphone to produce an audio stream.

During a virtual meeting established by the virtual meeting manager 208, the meeting server 102 receives a position of a cursor-control device 309 associated with the first computing device 106 (associated with a first user) (via the communications network 110). The meeting server 102 also receives live data from the data capture device 310 associated with the first computing device 106 (associated with the first user) (via the communications network 110). As described above, the live data may be live video data, live audio data, or a combination thereof. As described in more detail below, the meeting server 102 provides an object within the virtual meeting (involving the first user and a second user) that displays the live data (or a representation thereof, such as an avatar), wherein the object is associated with and moves with the position of the cursor-control device 309 associated with the first computing device. Thus, as a user participating in the virtual environment views a cursor controlled by another user participating in the virtual environment, the user can more easily identify what user is moving the cursor and any other input (audio or video input) provided by the user moving the cursor. As noted above, in some embodiments, such objects are referred to herein as living avatars as they associate a cursor with additional live input provided by a user associated with the cursor. Live input may be, for example, a cursor input, input from a device sensor, voice controls, typing input, keyboard commands, map coordinate positions, and the like.

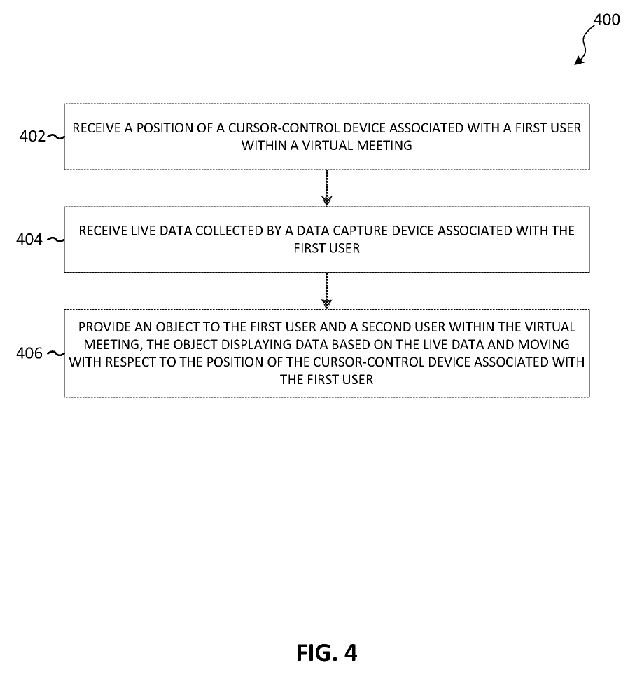

For example, FIG. 4 illustrates a method 400 for providing a living avatar within a virtual meeting. The method 400 is described as being performed by the meeting server 102 and, in particular, the electronic processor 202 executing the virtual meeting manager 208. However, it should be understood that in some embodiments, portions of the method 400 may be performed by other devices, including for example, the first computing device 106 and the second computing device 108.

As illustrated in FIG. 4, as part of the method 400, the electronic processor 302 receives (via the first computing device 106) a position of a cursor-control device 309 associated with a first user (at block 402). The position of the cursor-control device indicates where the first user's cursor is positioned within the virtual environment as presented on a display of the first computing device 106. The cursor's position may be indicated in two-dimensional space (using X-Y coordinates) or three-dimensional space (using X-Y-Z coordinates), depending on the nature of the virtual environment.

The electronic processor 302 also receives (via the first computing device 106) live data collected by a data capture device 310 (for example, a camera, a microphone, or both) associated with the first user (at block 404). In some embodiments, the live data includes a live video stream of the user interacting with the first computing device 106, a live audio stream of the user interacting with the first computing device 106, or a combination thereof.

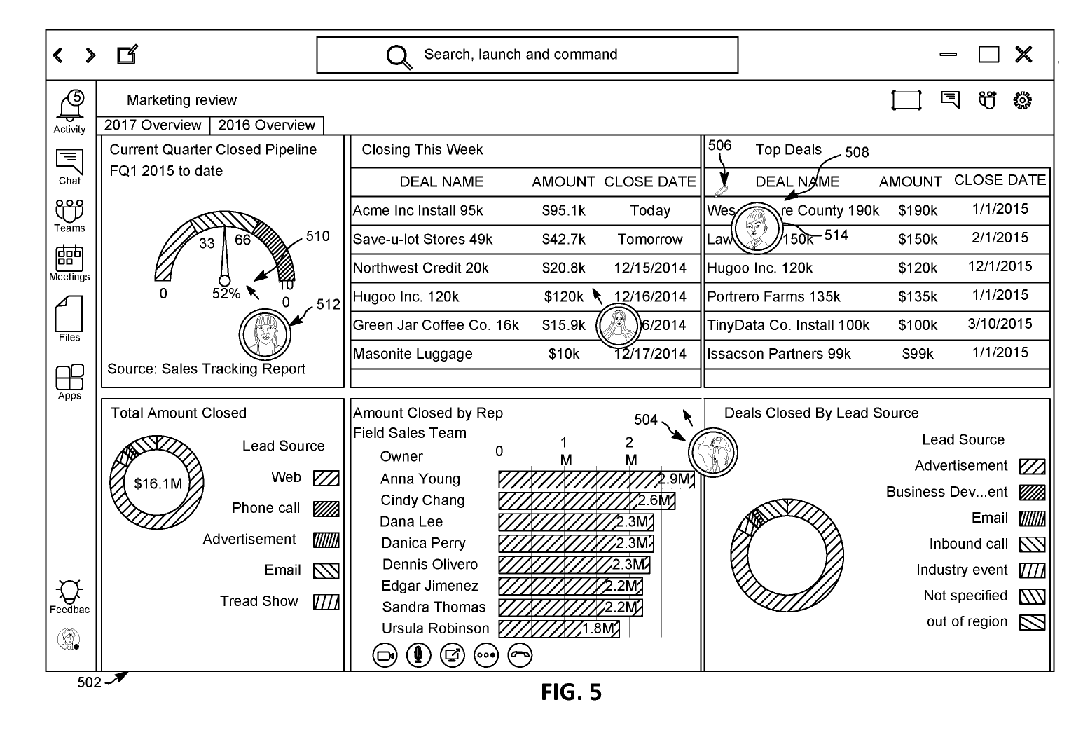

In some embodiments, the electronic processor 302 also receives shared content (via the first computing device 106) associated with the first user. As described above, the shared content may be a shared desktop of the first computing device 106, including multiple windows and applications, or the like. For example, FIG. 5 illustrates shared content 502 provided within a virtual meeting. Alternatively or in addition, the electronic processor 302 may receive shared content from other users participating in the virtual meeting, the memory 204, a memory included in a device external to the meeting server 102, or a combination thereof. Also, in some embodiments, a virtual meeting may not provide any shared content and may just provide an collaborative environment to users, in which the users may interact and communicate. In such embodiments, the virtual meetings are recorded, and interactions from users may be left in the recorded meeting for other users to encounter and play back at later times.

In some embodiments, the virtual meeting is an immersive virtual reality or augmented reality environment. In such embodiments, the environment may be three-dimensional, and, accordingly, the cursors and objects may move three-dimensionally within the environment.

Returning to FIG. 4, the electronic processor 302 provides (via the communications network 110), to the first user and a second user participating in the virtual meeting, an object within the virtual meeting (at block 406). The object displays live data based on the live data received from the data capture device 310 associated with the first user. The object also moves with respect to the position of the cursor-control device 309 associated with the first user.

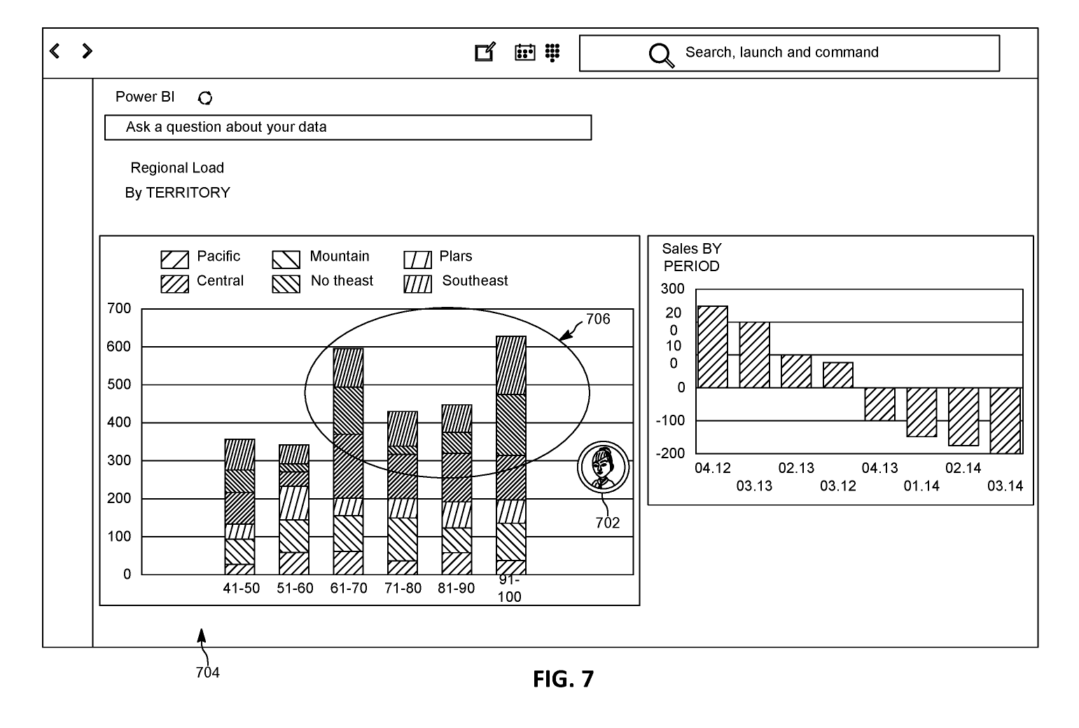

For example, as illustrated in FIG. 5, a virtual meeting provides a cursor 504 associated with a user, wherein the cursor 504 is represented as a pointer. In some embodiments, the graphical representation of a cursor provided within the virtual meeting changes based on characteristics, rights, or current activity of the associated user. For example, as illustrated in FIG. 5, when a user has the capability to markup or annotate shared content, a cursor 506 may be represented as a pencil. A cursor 706 may also be represented by an annotation being generated by a user (see FIG. 7).

As also illustrated in FIG. 5, an object 508 is displayed adjacent (in proximity) to the cursor 506. As a user moves the cursor 506 (via a cursor-control device 309) within the virtual meeting, the object 508 moves with the cursor 506, for example, at the same pace and in the same path as the cursor 506. In some embodiments, the object 508 maintains a fixed position relative to the cursor 506 (for example, the object 508 may always display to the lower right of the cursor 506). In other embodiments, the object 508 may move with respect to the cursor 506 but the position of the object 508 relative to the cursor 506 may change. It should be understood that the object 508 may be separate from the cursor 506 as illustrated in FIG. 5 or may be included in the cursor 506. For example, the object 508 may act as a representation of a user's cursor.

As noted above, the live data displayed via in the object is based on the received live data. In some embodiments, the object displays the received live data itself. For example, the object may include the live video stream associated with a user (see object 512 associated with cursor 510). This configuration allows other users to see and hear the words, actions, and reactions of the user as the user participates in the virtual meeting and moves his or her cursor.

Alternatively, the object 508 includes a live (or living) avatar generated based on the received live data (see also object 702 illustrated in FIG. 7). An avatar is a graphical representation of a user, for example, an animated figure. A living avatar may be two-dimensional or three-dimensional. In some embodiments, the living avatar is an animated shape. In other embodiments, the living avatar resembles the user, which it represents. In such embodiments, the living avatar may be a full-body representation, or it may only represent portions of the user (for example, the body from the waist up, the head and shoulders, or the like). Such a living avatar is a representative of the received live data. For example, the electronic processor 302 analyzes the received live data (for example, using motion capture or motion analysis software) to capture facial or body movements of the user (for example, gestures), and animates the avatar to closely mimic or duplicate the movements. In particular, when the user is speaking, the mouth of the avatar may move and, when the user shakes his or her head, the living avatar shakes its head similarly. In some embodiments, the animation focuses on the facial features of the avatar, while some embodiments also include hand and body movements. Thus, the avatar conveys visual or other input (motions) of the user without requiring that the user share a live video stream with the other users participating in the virtual meeting.

In some embodiments, the movements of the living avatar may be based on other inputs (for example, typing, speech, or gestures). For example, when the user enters an emoji, the face of the avatar may animate based on the feeling, emotion, or action represented by the emoji. In another example, a user may perform a gesture, which is not mimicked by the avatar, but is instead used to trigger a particular animation or sequence of animations in the avatar. In another example, a voice command, for example, followed by a keyword to activate the voice command function, does not result in the avatar speaking, but is instead used to trigger a particular animation or sequence of animations in the avatar. In some embodiments, the avatar may perform default movements (for example, blinking, looking around, looking toward the graphical representation of the active collaborator, or the like), such as when no movement is detected in the received live data or when live data associated with a user is unavailable. Similarly, a live avatar may stay still or appear to sleep when a user is muted, on hold, checked out, or otherwise not actively participating in the virtual meeting.

Alternatively or in addition, in some embodiments, the live data displayed by an object may include an animation of audio data received from a user. For example, the object (or a portion thereof) may pulse, change color, size, pattern, shape, or the like based on received audio data, such as based on the volume, tone, emotion, or other characteristic of the audio data. In some embodiments, the animation may also include an avatar whose facial expressions are matched to the audio data. For example, the avatar's mouth may open in a sequence that matches words or sounds included in the received audio data and the avatar's mouth may open widely or narrowly depending on the volume of the received audio data.

In some embodiments, the electronic processor 302 blocks certain movements of the user from affecting the animations of the living avatar. For example, excessive blinking, yawning, grooming (such as scratching the head or running fingers through the hair), and the like may not trigger similar animations in the avatar. In some embodiments, the user's physical location (for example, as determined by GPS), virtual location (for example, within a virtual reality environment) or local time for the user may affect the animations of the avatar.

In some embodiments, an object includes an indicator that communicates characteristics of the user to the other users participating in the virtual meeting. For example, as illustrated in FIG. 5, the object 508 includes an indicator 514, in the form of a ring. In some embodiments, the indicator 514 (or a property thereof) represents a state of the user. For example, the ring may change from one color to another when the user is active in the virtual meeting or inactive in the virtual meeting. A user may have an active state when the user is currently (or has recently) provided input to the virtual meeting (via video, text, audio, cursor movements, or the like). In another example, the indicator 514 may change size to reflect a change in state. In another example, when users can annotate shared content provided within the virtual meeting, the indicator 514 may change color to match the color of the user's annotations.

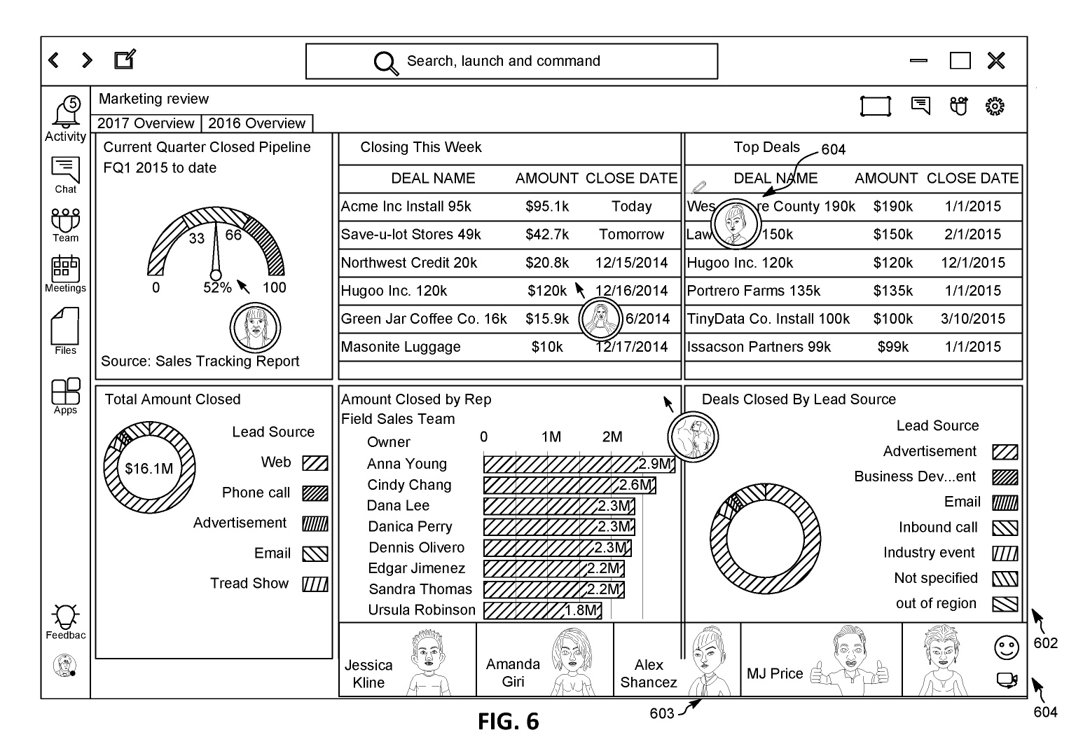

In some embodiments, the electronic processor 302 provides an object in different portions of the collaborative environment depending on the user's state. For example, as illustrated in FIG. 6, the electronic processor 302 provides an object 604 (displaying a living avatar) within shared content 602 provided within the virtual meeting when a user has an active state (for example, the user is currently or was recently speaking, gesturing, annotating the shared content 602, moving his or her cursor, or generally providing input to the virtual meeting). However, when a user has an inactive state (for example, the user is not currently or wasn't recently speaking, gesturing, annotating the shared content 602, moving his or her cursor, or generally providing input to the virtual meeting), the electronic processor 302 provides an object 603 within a staging area 604 of the virtual meeting. In some embodiments, the electronic processor 202 may provide an object in either the staging area 604 or the shared content 602. In other embodiments, the electronic processor 202 may provide an object in both the staging area 604 and the shared content 602 simultaneously.

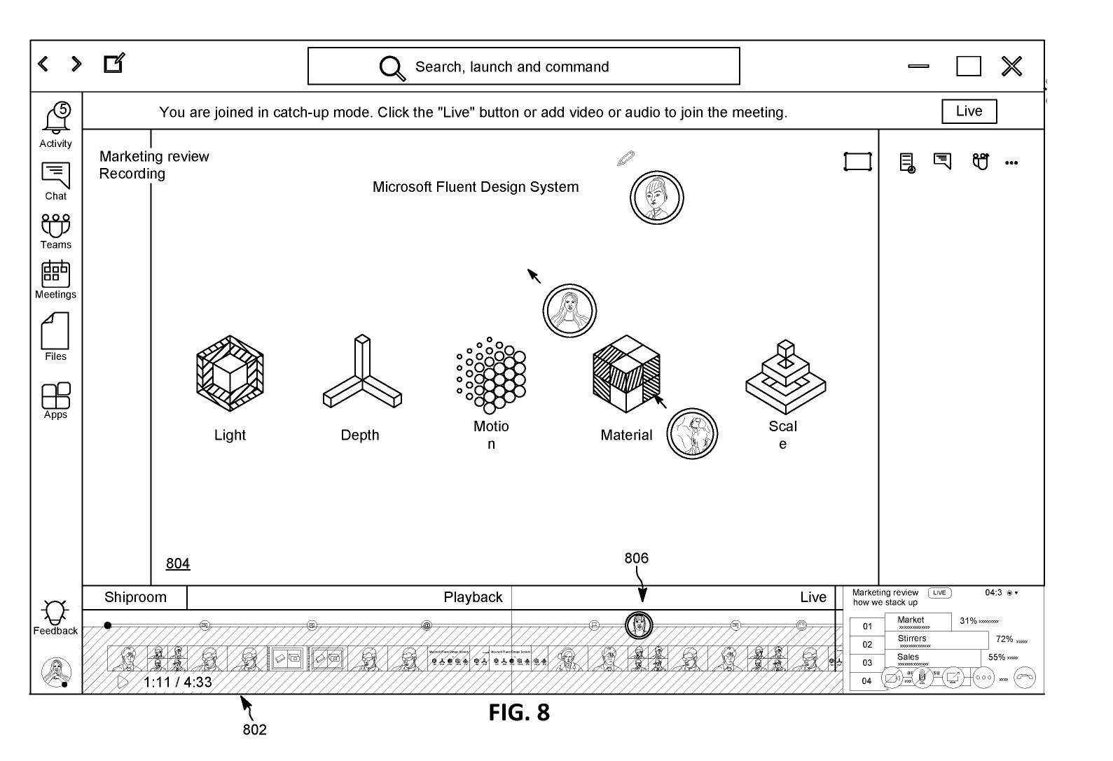

In some embodiments, the electronic processor 202 records virtual meetings and allows users to replay a virtual meeting. In such embodiments, the electronic processor 202 may record the objects provided with the virtual meeting as described above. Also, the electronic processor 202 may track when such objects were provided and may provide markers of such events within a recording. For example, as illustrated in FIG. 8, a recording of a virtual meeting 804 may include a video playback timeline 802, which controls playback of the virtual meeting 804. The timeline 802 includes one or more markers 806 indicating when during the virtual meeting an object was provided or when a user associated with such an object had an active state. The markers 806 may resemble the provided objects. For example, the markers 806 may include an image or still avatar displayed by the object. Accordingly, using the markers 806, a user can quickly identify when during a virtual meeting a user was providing input to the virtual meeting and jump to those portions of the recording.

Thus, embodiments provide, among other things, systems and methods for providing a cursor within a virtual meeting, wherein the cursor includes or is associated with live data associated with a user. As noted above, the functionality described above as being performed by a server may be performed on one or more other devices. For example, in some embodiments, the computing device of a user may be configured to generate an object and provide the object other users participating in a virtual meeting (directly or through a server). Various features and advantages of some embodiments are set forth in the following claims.

What is claimed is:

1. A system for providing a living avatar within a virtual meeting, the system comprising:
an electronic processor configured to
receive a position of a cursor-control device associated with a first user within the virtual meeting,
receive live image data collected by an image capture device associated with the first user, and
provide, to the first user and a second user, an object within the virtual meeting, wherein the object displays live visual data based on the live image data and wherein the object moves with respect to the position of the cursor-control device associated with the first user.

2. The system of claim 1, wherein the virtual meeting includes shared content received from a computing device associated with the second user.

3. The system of claim 2, wherein the shared content is at least one selected from a group consisting of a desktop and an application window.

4. The system of claim 1, wherein the live visual data includes the live image data.

5. The system of claim 1, wherein the live visual data includes a live avatar representative based on the live image data.

6. The system of claim 1, wherein the object includes an indicator and wherein the electronic processor is further configured set a property of the indicator based on a state of the first user.

7. The system of claim 1, wherein the object includes an indicator and wherein the electronic processor is further configured to animate the indicator based on live audio data received from the first user.

8. The system of claim 1, wherein the electronic processor is configured to provide the object within shared content provided within the virtual meeting when a state of the first user is active and provide the object within a staging area within the virtual meeting when the state of the first user is inactive.

9. The system of claim 1, wherein the virtual meeting includes one selected from a group consisting of a virtual reality environment and an augmented reality environment.

10. The system of claim 1, wherein the cursor-control device associated with the first user includes one selected from a group consisting of a mouse, a trackball, a touchpad, a touchscreen, a stylus, a keypad, a keyboard, a dial, and a virtual reality glove.

11. A method for providing a living avatar within a virtual meeting, the method comprising:
receiving, with an electronic processor, a position of a cursor-control device associated with a first user within the virtual meeting;
receiving, with the electronic processor, live image data collected by an image capture device associated with the first user;
providing, with the electronic processor, an object to the first user and a second user within the virtual meeting, wherein the object displays the live image data and wherein the object moves with respect to the position of the cursor-control device associated with the first user.

12. The method of claim 11, further comprising
determining a state of the first user, the state including one selected from a group consisting of an active state and an inactive state; and
setting a property of an indicator included in the object based on the state of the first user.

13. The method of claim 11, further comprising animating an indicator included in the object based on live audio data associated with the first user.

14. The method of claim 11, wherein providing the object includes
providing the object within shared content provided within the virtual meeting in response to the first user having an active state, and
providing the object within a staging area within the virtual meeting in response to the first user having an inactive state.

15. The method of claim 14, further comprising
generating a recording of the virtual meeting; and
providing a timeline for the recording, wherein the timeline includes a marker designating when the object was provided within the shared content.

16. The method of claim 11, wherein providing the object includes providing the object adjacent to a cursor associated with the first user.

17. The method of claim 11, wherein providing the object includes providing the object as part of a cursor associated with the first user.

18. A non-transitory computer-readable medium including instructions executable by an electronic processor to perform a set of functions, the set of functions comprising:
receiving a position of a cursor-control device associated with a first user within a virtual meeting;
receiving live data collected by a data capture device associated with the first user;
providing an object to the first user and a second user within the virtual meeting, wherein the object displays data based on the live data and wherein the object moves with respect to the position of the cursor-control device associated with the first user,
the data including at least one selected from a group consisting of live image data captured by the data capture device, a live avatar representation based on live image data captured by the data capture device, and a live animation based on live audio data captured by the data capture device.

19. The non-transitory computer-readable medium of claim 18, wherein providing the object includes
providing the object within shared content provided within the virtual meeting in response to the first user having an active state, and
providing the object within a staging area within the virtual meeting in response to the first user having an inactive state.

20. The non-transitory computer-readable medium of claim 19, wherein the set of functions further includes
generating a recording of the virtual meeting; and
providing a timeline for the recording, wherein the timeline includes a marker designating when the object was provided within the shared content.
